(19) United States
(12) Patent Application Publication
(10) Pub. No.: US 2026/0287137 A1
(43) Pub. Date: Sep. 24, 2026

(54) LIGHTING MODULE CONFIGURED TO PERFORM TWO LIGHTING FUNCTIONS

(71) Applicant: VALEO VISION, Bobigny (FR)

(72) Inventors: Pierre ALBOU, Bobigny (FR); Marine COURCIER, Bobigny (FR); Theo ARTUS, Bobigny (FR); Maud MANNE, Bobigny (FR)

(73) Assignee: VALEO VISION, Bobigny (FR)

(21) Appl. No.: 19/471,758

(22) PCT Filed: Mar. 27, 2024
(86) PCT No.: PCT/EP2024/058403

§ 371 Date: Oct. 2, 2025

(30) Foreign Application Priority Data
Apr. 3, 2023 (FR) FR2303281

(51) Int. Cl. F21S 41/20; F21S 43/20

(52) U.S. Cl. CPC F21S 41/285; F21S 43/26231

(57) ABSTRACT

The present invention relates to a luminous module (1) configured to perform a first luminous function and a second luminous function which is distinct from the first luminous function, the luminous module (1) comprising a housing (18) within which at least one light-emitting assembly, one collimator (4) and one microlens array device (6) are accommodated, the light-emitting assembly (2) being configured to emit light rays in the direction of the microlens array device (6) through the collimator (4) in order to perform either of the two luminous functions, the luminous module (1) comprising an actuator (20) which, when activated, causes the housing (18) to pivot when one of the two luminous functions is being switched to the other.

### TECHNICAL FIELD

The present invention relates to the field of luminous modules with which vehicles are intended to be equipped, and more particularly such luminous modules that are capable of generating a plurality of luminous functions.

### BACKGROUND OF THE INVENTION

Vehicles, and in particular automotive vehicles, are commonly equipped with headlamps making it possible to generate various luminous functions, which in particular allow illumination of the road or indeed signaling of the presence of the vehicle to other users. For example, such illumination corresponds to a low- or dipped-beam function, while such signaling corresponds to DRL functions (DRL being the abbreviation of Day Running Light) or indeed, inter alia, position-light functions or indicator-light functions allowing a change of direction to be signaled.

The lamps of automotive vehicles are increasingly compact and in them the same luminous module is able to generate a plurality of luminous functions and in particular both a lighting function and a signaling function.

In this context, it is sought to emit light beams specific to each of the luminous functions generated by the module through the same lighting area. In other words, with the aim of increasing the visual uniformity of the lighting of a vehicle, it is desired for an observer located outside the vehicle to see the same area illuminated, irrespectively of whether the lamp is performing a lighting function or a signaling function. The illuminated area is thus identical day and night.

In certain applications, a luminous function is performed via emission of light rays by a light source through a microlens array device, also known by the acronym MLA for microlens array.

However, the microlens array devices of the prior art are unsuitable for emitting two different luminous functions, and in particular for emitting a lighting function and a signaling function. The present invention aims to overcome this drawback by providing a luminous module in which the microlens array device is suitable for performing two different luminous functions, and in particular for emitting a lighting function and a signaling function.

### SUMMARY OF THE INVENTION

The principal subject of the present invention is thus a luminous module for automotive vehicle configured to perform a first luminous function and a second luminous function distinct from the first luminous function, the luminous module comprising a housing in which are accommodated a light-emitting assembly, a collimator and a microlens array device, the light-emitting assembly being configured to emit light rays toward the microlens array device through the collimator with a view to alternately performing each of the two luminous functions, the luminous module comprising an actuator, activation of which causes the housing to pivot during passage from one of the luminous functions to the other.

The luminous module according to the invention is intended to equip a vehicle, an automotive vehicle for example, with a view to achieving a pair of luminous functions that are different from each other. Within this luminous module, light rays are generated by a light-emitting assembly that comprises at least one light source, for example a light-emitting diode, and the connecting elements required to connect this light source. The light rays generated by the light-emitting assembly pass through a collimator before passing through a microlens array device. The light-emitting assembly, collimator and microlens array device are all three placed within a housing, which is a cavity that may contain other elements required to implement the luminous functions.

The luminous module according to the invention makes it possible to implement two distinct luminous functions that, for regulatory reasons, must be performed alternately. In other words, a first luminous function cannot be implemented when the other is being performed.

The luminous module is capable of performing these two luminous functions alternately, while meeting the regulatory standards of light emission of each of the functions, by moving the housing. The housing is controllable via an actuator, or level corrector; more precisely, this actuator allows the housing to pivot. Such pivoting occurs during passage from the first luminous function to the second luminous function, or vice versa during passage from the second luminous function to the first luminous function. The housing thus has two distinct angular positions. The housing will be in a first angular position when the first luminous function is being performed and in a second angular position when the second luminous function is being performed. The luminous module passes from the first luminous function to the second luminous function as a result of pivoting of the housing from the first angular position to the second angular position, and conversely to pass from the second luminous function to the first luminous function the housing is pivoted by the actuator from the second angular position to the first angular position.

The present luminous module thus allows two different luminous functions to be performed through the same illuminated area of the automotive vehicle.

According to one optional feature of the invention, the first luminous function is a signaling function, such as a daytime-running-light function, and the second luminous function is a lighting function, such as a low-beam function.

In other words, implementation of the first luminous function, i.e. the signaling function, causes activation of the daytime running lights of the automotive vehicle, whereas implementation of the second luminous function, i.e. the lighting function, causes activation of the low-beam lights of this vehicle, which are the lights used at night, alternately to the lights of the first luminous function.

According to one optional feature of the invention, the second luminous function has an upper cutoff. Such an upper cutoff makes it possible to avoid causing discomfort glare to road users who have to pass the vehicle equipped with a luminous module according to the invention.

According to one optional feature of the invention, the microlens array device comprises an entrance microlens array, an exit microlens array and a mask, the mask being placed between the two microlens arrays.

The entrance microlens array corresponds to the portion of the microlens array device through which light rays enter this microlens array device, and similarly the exit microlens array corresponds to the portion of the microlens array device through which light rays leave it.

Each of the entrance microlens array and exit microlens array comprises a plurality of microlenses, which here are convergent lenses. Such microlenses have dimensions of the order of one millimeter. The organization of the microlens array device is such that a given microlens of the entrance microlens array interacts with a single microlens of the exit microlens array. The shape of the microlenses is thus simplified and facilitates their manufacture. Here, it will be understood that two microlenses “interact” when a light ray or a plurality of light rays having passed through a microlens of the entrance microlens array also pass through a microlens of the exit microlens array.

The entrance microlens array receives the light rays before the exit microlens array; it will be understood that the entrance microlens array is placed between the collimator and the exit microlens array.

The mask is interposed between the entrance microlens array and the exit microlens array. The mask may for example make it possible to define a border between this entrance microlens array and this exit microlens array.

According to one optional feature of the invention, the entrance microlens array has an image focal plane and the exit microlens array has an object focal plane, this image focal plane and this object focal plane being substantially coincident.

More precisely, each of the microlenses of the entrance microlens array has an image focal plane that is coincident with an object focal plane of the microlens of the exit microlens array with which it interacts.

According to one optional feature of the invention, the image focal plane of the entrance microlens array and the object focal plane of the exit microlens array are substantially coincident with the mask.

By substantially coincident, what should be understood is that, in theory, the focal planes are perpendicular to an optical axis of the microlens array device and are superposed with the mask but that, in fact, the focal planes may be side by side, slightly offset with respect to each other. As a result, each of the image foci of the entrance microlenses is placed on the mask, or substantially on the mask, and in the same way, each of the object foci of the exit microlenses is placed on this mask, or substantially on this mask.

According to one optional feature of the invention, the mask is opaque and contains apertures.

This mask is for example a glass plate that is embedded in the material of the microlens array device, at least one of the glass plate's sides located facing one of the microlens arrays being coated with an opaque coating. The mask contains apertures, which correspond to windows in the opaque coating, which allow localized passage of the formed light rays from the entrance microlens array to the exit microlens array.

According to one optional feature of the invention, each microlens of the entrance microlens array has an image focal plane, the light rays generated by the light-emitting assembly and participating in the first luminous function being focused on the image focal plane, at a first focal point away from the edges of the apertures of the mask, and the light rays generated by the light-emitting assembly and participating in the second luminous function being focused on the image focal plane, at a second focal point on the edge of an aperture of the mask.

Each first focal point associated with the light rays participating in the first luminous function is placed in one of the apertures of the mask, at a distance from the edges of this aperture.

Each second focal point associated with the light rays participating in the second luminous function is placed on the edge of an aperture, this edge being a cutoff edge.

The apertures are formed in the mask in such a way that there is, for each focal point associated with the light rays participating in the first or second luminous function, one given aperture; thus, there is a corresponding aperture for each entrance microlens.

For a given entrance microlens, the first focal point associated with the light rays participating in the first luminous function is offset from the cutoff edge of its corresponding aperture according to the formula DC/f2>tan(10°), where DC is a distance between a point D which is the first focal point associated with the light rays participating in the first luminous function and a point C which is the second focal point associated with the light rays participating in the second luminous function, and where f2 is the focal length of the corresponding exit microlens, i.e. here the distance between the mask and this corresponding exit microlens.

According to one optional feature of the invention, the luminous module comprises a control unit controlling the actuator.

According to one optional feature of the invention, the luminous module comprises an additional actuator, activation of which causes a movement of at least part of the luminous module within the housing, the control unit being configured to control the actuator and the additional actuator simultaneously.

The actuator that makes the housing pivot then corresponds to a first actuator, the additional actuator being a second actuator of the luminous module. The first actuator allows an angular position of the housing in its entirety to be modified, while the second actuator allows a position of at least one element of the luminous module placed in the housing to be modified. The control unit is capable of controlling the first actuator and the second actuator at the same time; thus, it is possible to modify the angular position of the housing and the position of the element placed inside the housing simultaneously.

According to one optional feature of the invention, the part of the luminous module corresponds to the microlens array device, the light-emitting assembly comprising a light source having a variable luminous intensity.

According to one optional feature of the invention, the microlens array device is configured to switch between a first angular position and a second angular position.

This is a first variant of embodiment, in which the additional actuator is configured to modify the position of the microlens array device. This allows this microlens array device to be oriented between a first angular position and a second angular position. In this first variant of embodiment, the luminous module, and in particular the light-emitting assembly, comprises a single light source, which is of variable luminous intensity. The orientation of the microlens array device in the first angular position allows it to be placed in such a way that it receives light rays from the light source for performance of the first luminous function, while its orientation in the second angular position allows it to be placed in such a way that it receives light rays for performance of the second luminous function.

According to one optional feature of the invention, the part of the luminous module corresponds to the light-emitting assembly.

According to one optional feature of the invention, the light-emitting assembly comprises a light source movable between a first position and a second position, the first position being associated with the first luminous function and the second position being associated with the second luminous function, the light source having a variable luminous intensity.

In this second variant of embodiment, the light-emitting assembly comprises a light source which is a single light source. It is movable between the first position which allows the first luminous function to be performed and the second position which allows the second luminous function to be performed. Since the two luminous functions require different luminous intensities, the single light source has a variable luminous intensity in order to be able to handle both luminous functions.

According to one optional feature of the invention, the light-emitting assembly comprises a first light source configured to perform the first luminous function and a second light source configured to perform the second luminous function.

In this embodiment, there is a plurality of light sources each configured to perform one of the two luminous functions. The light sources may be selectively addressable, i.e. they may be activated independently of each other, for example by the control unit.

According to one optional feature of the invention, the collimator has an object focal plane, the two light sources being placed in this object focal plane.

The light sources are for example placed in such a way that one is placed on a first side of an optical axis and the other is placed on another side of the optical axis of the luminous module, which optical axis is drawn in a main direction of propagation of the light rays within the module. The two light sources may be placed at the same distance from the collimator and equidistant from the optical axis.

According to one optional feature of the invention, the two light sources are placed on the same printed circuit board of the light-emitting assembly.

It will be understood that the light-emitting assembly comprises both the light sources and the printed circuit board bearing them. Such an arrangement reduces the number of components required to produce the luminous module and furthermore facilitates its installation, the light sources being easily alignable in a plane substantially parallel to the collimator.

According to one optional feature of the invention, the two light sources are placed in two different vertical planes, each perpendicular to an optical axis of the luminous module, one of the light sources being closer to the microlens array device than the other light source.

The light sources are then at different distances from the collimator. The closest light source is the first light source, i.e. the light source that advantageously allows the signaling function to be implemented.

According to one optional feature of the invention, the collimator has an object focal plane, the second light source being placed in this object focal plane and the first light source being offset with respect to this object focal plane.

One of the light sources is placed in the object focal plane of the collimator while the other is not placed in the object focal plane. More precisely, the light source performing the lighting function is placed in the object focal plane while the light source performing the signaling function is offset with respect thereto. In certain embodiments, the first light source is closer to the collimator, i.e. it is placed between the collimator and its object focal plane. In other embodiments, the first light source is further away from the collimator, and the object focal plane of the collimator is then interposed between the first light source and the collimator.

According to one optional feature of the invention, the luminous module comprises an additional lens placed between the first light source and the microlens array device.

Interposition of an additional lens between the first light source and the microlens array device makes it possible to defocus it without modifying its position with respect to the second light source; the two light sources may for example both be placed in the object focal plane of the collimator. The additional lens is in particular made of plastic.

In the context of a first light source corresponding to implementation of a daytime-running-light function, which involves a regulatory beam that is of greater vertical extent than the regulatory beam associated with the dipped-beam function in particular, it is advantageous to place a lens facing the first light source, so as to promote spreading of the beam.

According to one optional feature of the invention, the light sources have different luminous intensities.

In particular, the first light source has a lower luminous intensity than the second light source.

According to one optional feature of the invention, the actuator is configured to make the housing pivot by an angular offset of between 5° and 15°.

In other words, the housing passes from a first angular position to a second angular position, or vice versa, by pivoting by an angle of between 5° and 15°. The actuator is thus configured to pivot the housing by at least 5°. Such a value distinguishes the actuator of the invention from conventional level correctors, which are dimensioned to move a luminous module by an angular displacement of at most 4°. Here, either the actuator is a different element from the level corrector of the vehicle and it then operates in distinct ranges of values, or it corresponds to the level corrector that has been configured differently to allow a greater angular displacement, in order to make pivoting from 5° to 15° possible.

The invention also relates to an automotive vehicle comprising at least one luminous device such as described above.

The invention further relates to a method for using a luminous module such as described above, wherein detection of passage from the first luminous function to the second luminous function causes the actuator to be activated to make the housing pivot from a first angular position to a second angular position, and detection of passage from the second luminous function to the first luminous function causes the actuator to be activated to make the housing pivot from the second angular position to the first angular position.

The housing therefore pivots as a result of detection, for example by a device associated with the control unit, of passage from one of the luminous functions to the other.

### BRIEF DESCRIPTION OF THE DRAWINGS

Other features, details and advantages of the invention will become more clearly apparent on perusing the following description, on the one hand, and examples of embodiment that are given by way of indication and non-limitingly with reference to the appended drawings, on the other hand, in which drawings:

FIG. 1 schematically illustrates a luminous module capable of performing two luminous functions according to the invention, comprising a plurality of light sources, a collimator and a microlens array device, these elements being placed in a housing, FIG. 1 moreover illustrating a detail of the microlens array device;

FIG. 2 schematically illustrates another view of the luminous module of FIG. 1, in which light rays participating in each of the two luminous functions have been shown, the housing being in a neutral position;

FIG. 3 schematically illustrates part of the microlens array device of the luminous module of FIG. 1, this part of the microlens array device here participating in performance of the first luminous function, the housing being in a first angular position;

FIG. 4 schematically illustrates the part of the microlens array device illustrated in FIG. 3 and here participating in performance of the second luminous function, the housing being in a second angular position;

FIG. 5 schematically illustrates a variant of the luminous module of FIG. 1, in which this luminous module comprises a single light source that is movable;

FIG. 6 schematically illustrates another variant of the luminous module of FIG. 1, in which the light sources are offset with respect to the collimator;

FIG. 7 schematically illustrates another variant of the luminous module of FIG. 1, in which a lens is inserted between one of the light sources and the collimator; and

FIG. 8 schematically illustrates another variant of the luminous module of FIG. 1, in which this luminous module comprises a single light source that is fixed, the microlens array device being able to rock.

### DETAILED DESCRIPTION OF THE INVENTION

The features, variants and various embodiments of the invention may be associated with one another in various combinations, provided that they are not mutually incompatible or mutually exclusive. In particular, it is possible to imagine variants of the invention comprising only a selection of the features described below, independently of the other described features, if this selection of features is sufficient to confer a technical advantage and/or to differentiate the invention from the prior art.

In the figures, elements that feature in multiple figures have been given the same reference sign in all of them.

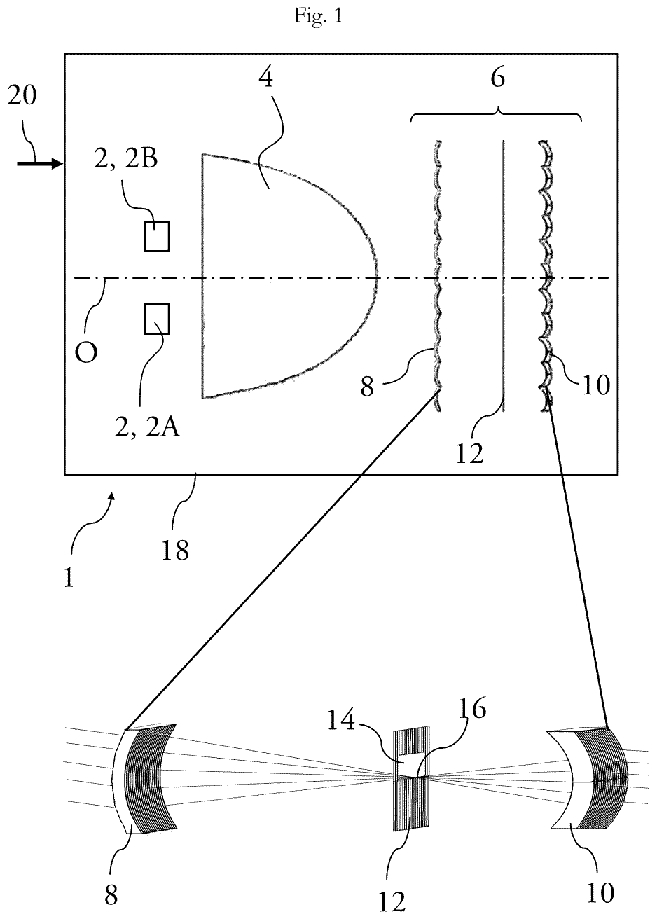

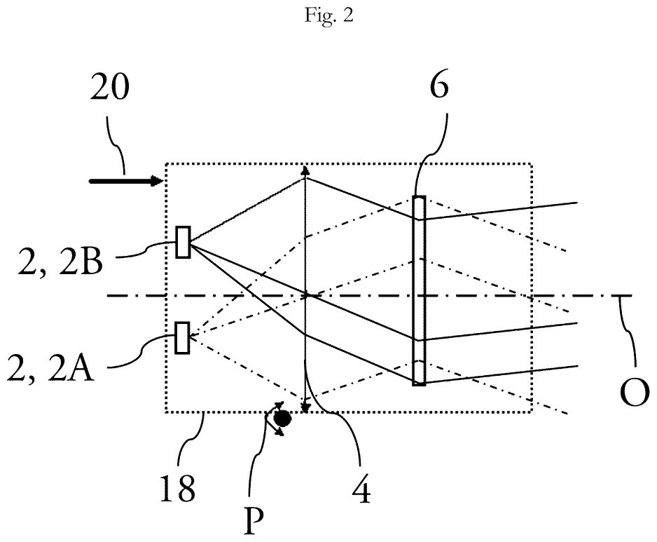

FIG. 1 and FIG. 2 thus schematically illustrate a luminous module 1 according to the invention, such a luminous module 1 for example being intended to equip a vehicle such as an automotive vehicle. This luminous module 1 is capable of alternately performing, within the automotive vehicle, a plurality of luminous functions, namely a first luminous function and a second luminous function different from the first luminous function.

The luminous functions performed by the luminous module 1, i.e. its first luminous function and its second luminous function, are a signaling function and a lighting function, respectively. More particularly, the signaling function corresponds to a daytime-running-light function of the automotive vehicle while the lighting function corresponds to a low-beam function of this vehicle. Passage from one of these luminous functions to the other within the luminous module 1 is achieved simultaneously with a pivoting motion, achieved by means of an actuator 20, of a housing 18 within which the various optical components of the luminous module 1 are housed; such a mechanism will be described below.

The luminous module 1 comprises a light-emitting assembly which is a means of emitting light rays. This light-emitting assembly comprises at least one light source 2. Thus, in the embodiments shown, there is either a first light source 2A and a second light source 2B, or a single light source 2. The light source 2 in particular takes the form of a light-emitting diode. It is configured to perform at least one luminous function within the luminous module 1, i.e. to emit light rays participating in at least one of the two luminous functions. In the presence of two light sources 2A, 2B, each is dedicated to performance of one of the luminous functions among the first luminous function and the second luminous function, whereas in the case of a single light source 2 the latter ensures both these first and second luminous functions.

The first luminous function and the second luminous function require different luminous powers. More particularly, the first luminous function, i.e. the signaling function, requires a lower luminous power than the luminous power required by the second luminous function, i.e. the lighting function. Therefore, when the light-emitting assembly comprises a single light source 2, the latter has a variable luminous intensity, and when the light-emitting assembly comprises both the first light source 2A dedicated to the first luminous function and the second light source 2B dedicated to the second luminous function, this light source 2B has a greater luminous intensity than the first light source 2A.

The light rays emanating from the light source 2, i.e. from the first light source, second light source or single light source, propagate within the luminous module 1 in a main propagation direction, in which an optical axis O of the luminous module 1 is drawn. This optical axis O for example extends, in a neutral position of the housing 18 unmoved by the actuator 20, in a horizontal direction substantially parallel to the ground on which the automotive vehicle with which the luminous module 1 is fitted rests. In the presence of a first light source 2A and a second light source 2B, these light sources are placed on either side of the optical axis O in a vertical direction substantially perpendicular to the ground, with the first light source 2A below the optical axis O and the second light source 2B above it. In the presence of a single light source 2, the latter will for example be placed on one side of the optical axis O, i.e. either below or above it.

The luminous module 1 comprises a collimator 4, which receives the light rays emitted by the light source 2. The collimator 4 thus has a first side facing the light source 2, which is the side through which the light rays enter, and a second side opposite the first side, through which the light rays leave. The collimator 4 is configured to deflect the light rays passing through it, so as to output a beam of light rays that are parallel to one another. In other words, the collimator 4 receives through its first side light rays that are not parallel because they are generated by the light source 2, and it reorients them so that when they leave through its second side they are parallel. In the presence of two light sources 2A, 2B for example, the collimator 4 is configured to direct the light rays emitted by the first light source 2A into a first beam of parallel rays, which has a given tilt with respect to the optical axis, and to direct the light rays emitted by the second light source 2B into a second beam of parallel rays, this second beam of parallel rays having a tilt with respect to the optical axis that is different from the corresponding tilt of the first beam of parallel rays. As may be seen in the figures, on exiting the collimator 4 the light rays participating in the first function form an ascending beam of rays, whereas on exiting the collimator the light rays participating in the second function form a descending beam of rays.

The light rays leaving the collimator 4 are directed toward a microlens array device 6 of the luminous module 1. In other words, the light rays generated by the light source 2 pass through the collimator 4 to reach this microlens array device 6. The microlens array device 6 comprises an entrance microlens array 8, an exit microlens array 10 and a mask 12, these elements particularly being shown in FIG. 1.

The entrance microlens array 8 corresponds to an entrance face of the microlens array device 6 and the exit microlens array 10 corresponds to an exit face thereof. The mask 12 is placed in the material of the microlens array device, between the entrance microlens array 8 and the exit microlens array 10. In other words, within the microlens array device 6, the light rays pass in order through the entrance microlens array 8, the mask 12 and then the exit microlens array 10.

Each of the entrance microlens array 8 and the exit microlens array 10 comprises a plurality of microlenses; it will be understood that there are a plurality of entrance microlenses and a plurality of exit microlenses, a given entrance microlens being configured to interact with a given exit microlens. A given entrance microlens is considered to interact with a given exit microlens when the light rays entering the microlens array device 6 via this entrance microlens leave this microlens array device 6 via this exit microlens, as is particularly illustrated in FIG. 1. Here, the microlenses are convergent lenses.

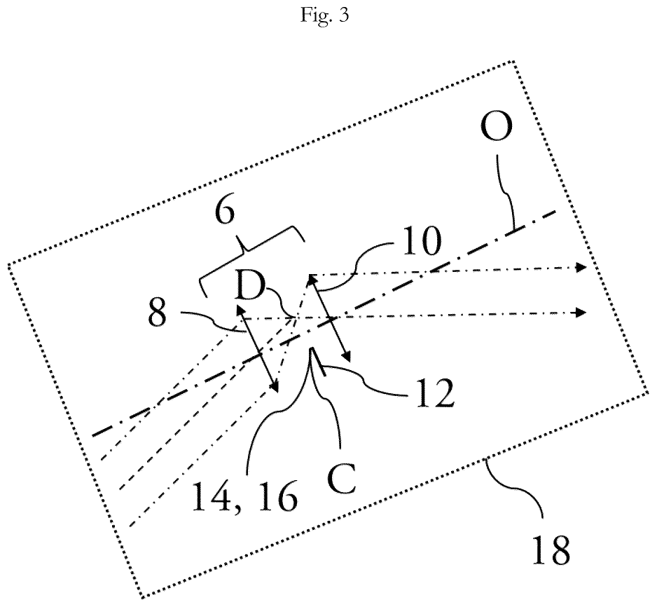

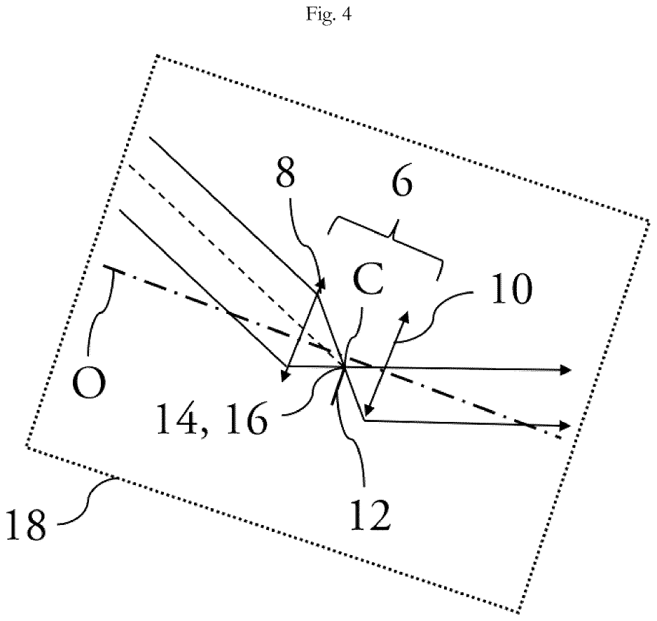

As illustrated in FIG. 3 and FIG. 4, the entrance microlens array 8 and the exit microlens array 10 are placed with respect to each other in such a way that an image focal plane of the entrance microlens array 8 and an object focal plane of the exit microlens array 10 are substantially coincident. The image focal plane of the entrance microlens array 8 and the object focal plane of the exit microlens array 10 are for example placed along the mask 12.

This mask 12, which is in particular shown in FIG. 1, is opaque. Such opacity for example results from one of the sides of the mask 2, which side is intended to be passed through by the light rays, being covered with a coating preventing passage of the light rays. In this opaquely covered surface are formed apertures 14, which allow localized passage of light rays through the mask. The mask 12 may for example be produced in such a way that each aperture 14 is placed in a light circulation channel, between a microlens of the entrance microlens array 8 and the corresponding microlens of the exit microlens array 10, the apertures 14 then each facing both a microlens of the entrance microlens array 8 and a microlens of the exit microlens array 10.

Each aperture 14 is bounded by an edge; it will be understood that this edge corresponds to an interface between an opaque portion of the mask 12, which prevents the passage of light rays, and a portion of the mask 12 that allows these light rays to pass.

As mentioned above, the second function is a lighting function. More particularly, the lighting function is here a low-beam function provided with an upper cutoff that makes it possible, during implementation of the second, lighting function, to avoid causing discomfort glare to road users traveling in the opposite direction to the automotive vehicle equipped with the luminous module 1 according to the invention.

Such an upper cutoff is obtained by orienting the light rays participating in the second luminous function so that they reach the mask 12 in a particular way. Thus, these light rays are directed toward one of the edges of an aperture 14 of the mask 12, as illustrated in FIG. 1 or FIG. 4, this edge more particularly being designated the cutoff edge 16. More precisely, each microlens of the entrance microlens array 8 is configured so that the light rays participating in the second luminous function are focused by said entrance microlens at a second focal point C, this second focal point C being centered on the cutoff edge 16 of the aperture 14 facing the given microlens. Light rays associated with the second luminous function may then be blocked by the opaque coating of the mask 12 should they be slightly defocused and run the risk of having an ascending trajectory on exiting the microlens array device. Such a placement of the second focal point C of each microlens of the entrance microlens array 8 makes it possible to obtain, at the exit of the microlens array device 6, a light beam with its upper part truncated, this light beam corresponding to the second luminous function of the luminous module 1.

Conversely, a cutoff is not necessary during implementation of the first luminous function, which corresponds to a signaling function. As a result, a first focal point D associated with the light rays participating in the first luminous function is, for each microlens of the entrance microlens array 8, off-center with respect to the edges of the apertures 14 of the mask 12 and in particular with respect to the cutoff edge 16 of these apertures; it will be understood that the first focal points D of the microlenses of the entrance microlens array 8 are, for the light rays of the first luminous function, each placed in one of the apertures 14 of the mask 12 but at a distance from the edges thereof, as may be seen in FIG. 3.

More precisely, for a given microlens of the entrance microlens array 8, the first focal point D associated with the light rays performing the first luminous function is offset from the cutoff edge 16 of the corresponding aperture 14 of the mask 12 according to the mathematical formula DC/f2>tan(10°), in which DC is the distance between the point D (first focal point associated with the light rays participating in the first luminous function) and the point C (second focal point associated with the light rays participating in the second luminous function), and in which f2 is the focal length of the corresponding microlens of the exit microlens array 10. The focal points C, D are in particular illustrated in FIG. 3 and FIG. 4.

The distance between points D and C, or interfocal distance DC between the first focal point associated with the light rays participating in the first luminous function on the one hand and the second focal point associated with the light rays participating in the second luminous function on the other hand, is on the one hand influenced by the need for the extent of the projection to correspond to a regulatory signaling-function beam, the beam not being cut off by the cutoff edge, and therefore the need for point D to be separated from point C, and on the other hand influenced by distances between various elements of the luminous module 1. This interfocal distance DC thus depends on the focal lengths of the collimator 4 and of the microlenses of the entrance microlens array 8 and on a distance between the two light sources 2A, 2B. Such an interfocal distance DC is more precisely expressed by the formula DC=f1AB/f0, where f0 is the focal length of the collimator 4, AB is the distance between the light sources 2A, 2B and f1 is the focal length of the microlenses of the entrance microlens array 8.

It will therefore be understood that, within the luminous module 1, the organization of the light-emitting assembly, collimator 4 and microlens array device 6 with respect to each other along the optical axis O is governed by the desired distance between the first focal point associated with the light rays participating in the first luminous function and the second focal point associated with the light rays participating in the second luminous function.

As mentioned above, the light-emitting assembly is placed, with respect to the optical axis O, in such a way that there is either one light source 2 placed on one side of the optical axis O, or two light sources 2A, 2B placed on either side thereof. Because of this placement, on exiting the microlens array device 6, the light rays participating in the first function form a beam of rays that is descending with respect to the optical axis O when the latter is substantially horizontal, while the light rays participating in the second function form a beam of rays that is ascending with respect to the optical axis O. The descending beam of rays is illustrated in FIG. 2 and FIG. 3 while the ascending beam of rays is shown in FIG. 2 and FIG. 4.

In the neutral position of the housing 18, as illustrated in FIG. 2, i.e. when the optical axis O is substantially horizontal, such beam orientations are however incompatible with the regulatory light-emission standards of each of the two luminous functions and do not allow satisfactory implementation thereof, in particular because, in the case of the first luminous function, the relevant orientation does not allow the automotive vehicle to signal its presence satisfactorily, and in the case of the second luminous function, the relevant orientation does not allow the road to be illuminated in a way befitting the second luminous function. The ascending beam of rays will, for example, cause road users discomfort glare, this leading to irritation and being contrary to regulations.

A correct orientation of the light rays, i.e. an orientation allowing both a satisfactory and compliant signaling function and a satisfactory and compliant lighting function to be obtained, corresponds to an orientation such that the beams of light rays of each of the luminous functions are, on exiting the microlens array device 6, substantially horizontal, i.e. substantially parallel to the ground on which the automotive vehicle equipped with the luminous module 1 is resting during implementation of the associated luminous function.

This orientation of the beams of light rays is obtained via a mechanical movement of the housing 18 of the luminous module 1. This housing 18 is a cavity within which the light-emitting assembly, collimator 4 and microlens array device 6 are placed. The mechanical movement of the housing allows all these elements to be pivoted, and therefore the optical axis O to be rocked. The housing 18 is shown in the figures schematically, so as to illustrate positioning of the various elements that it accommodates, in particular with respect to the optical axis O. Such positioning is not however representative of the dimensions and distances between these various elements.

The mechanical movement of the housing 18 is controlled by a control unit of the luminous module 1. This control unit is in particular capable of controlling the actuator 20 of the luminous module 1. The actuator 20 is thus configured to make the housing 18 pivot when the luminous module 1 passes from one of the luminous functions to the other, i.e. when it alternates between the first luminous function and the second luminous function and vice versa. The actuator 20 is for example an actuating finger that may be translated or indeed extended or retracted, an extension of this actuating finger causing the finger to push against a portion of the housing which, being mounted on a pivot P, pivots in a given direction of rotation, and conversely, a retraction of this actuating finger being able to cause the housing to return to its initial position via a rotational movement in the opposite direction about the pivot P. The housing here pivots P about an axis perpendicular to the optical axis O of the luminous module 1 and a vertical direction substantially perpendicular to the ground.

The pivoting motion of the housing 18 allows the optical axis O to be made to pivot so as to tilt it differently with respect to the horizontal, this making it possible to ensure that the light rays associated with the first luminous function and the light rays associated with the second luminous function are alternately oriented in compliance with regulations during implementation of their respective luminous functions. A correct orientation of the light rays associated with the first luminous function, i.e. an orientation such that they exit the microlens array device 6 substantially parallel to the ground, thus results from a first angular position of the housing 18. Similarly, a correct orientation of the light rays associated with the second luminous function, i.e. an orientation such that they exit the microlens array device 6 substantially parallel to the ground, results from a second angular position of the housing 18. The first angular position of the housing 18 is illustrated in FIG. 3, which therefore corresponds to the first luminous function, and the second angular position of this housing 18 is shown in FIG. 4, which corresponds to the second luminous function. The actuator 20 makes the housing 18 pivot from one of these angular positions to the other. The first angular position corresponds to a position in which the optical axis O, on exiting the luminous module, points away from the ground, as illustrated in FIG. 3, whereas the second angular position corresponds to a position in which the optical axis O points toward the ground, as may be seen in FIG. 4.

In other words, when the control unit detects that a user of the automotive vehicle equipped with the luminous module 1 according to the invention wants to pass from the first luminous function to the second luminous function, or when such passage is detected automatically, for example depending on a change in external light level, this control unit activates the actuator 20 so that the latter makes the housing 18 pivot from the first angular position to the second angular position. Similarly, when the user wishes to pass from the second luminous function to the first luminous function, or even when such passage occurs automatically, the control unit activates the actuator 20, which causes the housing 18 to pivot from its second angular position to its first angular position.

An angular offset between the first angular position and the second angular position of the housing 18 is here of the order of 10°, with tolerances of plus or minus 1° as a function of the dimensions of the luminous module 1. More generally, the angular offset is, for example, between 5° and 15°. For an angular offset of 10°, the actuator 20 may orient the housing 18 of the luminous module 1 by −5° with respect to its neutral position, i.e. by 5° in a first pivoting direction, or by +5° with respect to this neutral position, i.e. by 5° in a second pivoting direction opposite the first direction.

When the actuator 20 is a level corrector of the automotive vehicle equipped with the luminous module 1 according to the invention, this level corrector must be configured to allow a greater angular offset than a prior-art level corrector, the angular offset of which is generally limited to 4° in order to counteract any overloading of the automotive vehicle.

Various variants of embodiment of the luminous module 1 according to the invention will now be described. Unless otherwise stated, the features mentioned in relation to one of the variants may apply mutatis mutandis to another variant provided that such application is not incompatible.

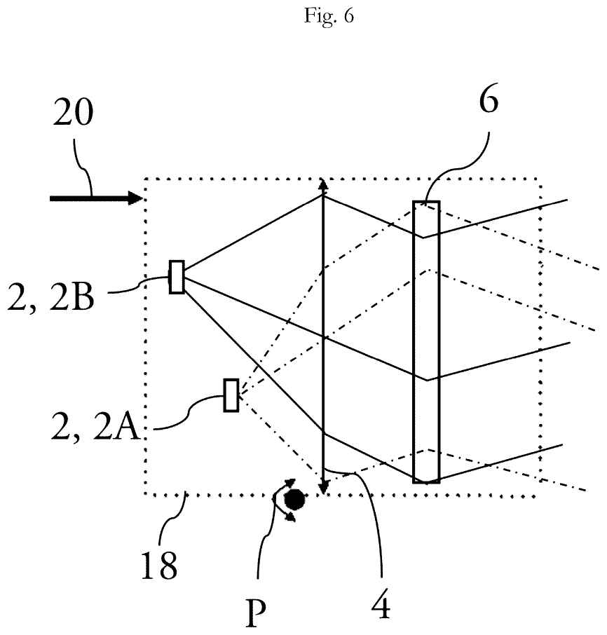

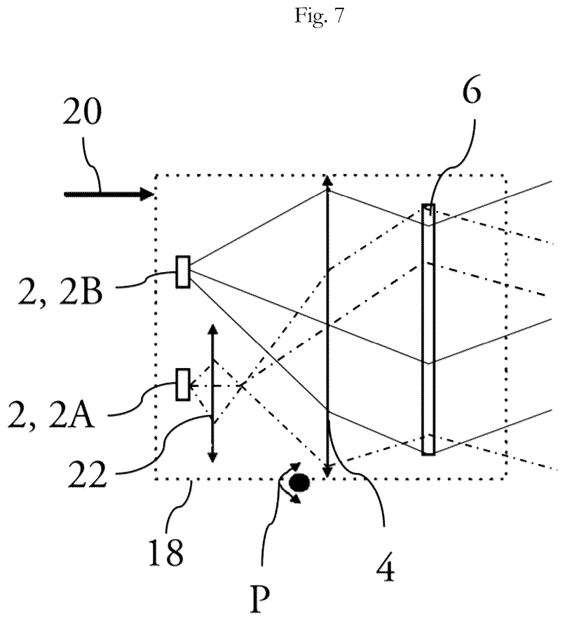

In the variants illustrated in FIG. 1, FIG. 2, FIG. 6 and FIG. 7, the luminous module 1 is equipped both with the first light source 2A participating in the first luminous function and with the second light source 2B participating in the second luminous function, these two light sources 2A, 2B being of different luminous intensities as was mentioned above. In the variants of FIG. 1, FIG. 2 and FIG. 7, the first light source 2A and the second light source 2B are placed in the same focal plane. These light sources 2 are, for example, placed in an object focal plane of the collimator 4, the first light source 2A then being on a first side of the optical axis O of the luminous module 1 and the second light source 22 being on a second side thereof. To this end, the first and second light sources 2A, 2B may in particular be mounted on the same printed circuit board (not shown here) of the light-emitting assembly, such a printed circuit board then being mounted within the luminous module 1 so as to be placed in a plane substantially perpendicular to the optical axis O of this luminous module 1.

In FIG. 7, the first light source 2A and the second light source 2B are in the same focal plane, but an additional lens 22 is placed between one of the light sources 2A, 2B and the collimator 4. More specifically, this additional lens 22 is positioned between the first light source 2A and the collimator 4. Such positioning makes it possible to defocus the first light source 2A, so that a beam of light rays generated by this second light source 2A is of greater extent on exiting the microlens array device 6. The additional lens 22, which is for example made of plastic, may be mounted on the printed circuit board of the light-emitting assembly carrying the two light sources 2A, 2B.

On the contrary, in the variant of embodiment shown in FIG. 6, the first light source 2A and the second light source 2B are not placed in the same focal plane. Here, the first light source 2A is placed in a first vertical plane substantially perpendicular to the optical axis O and the second light source 2B is placed in a second vertical plane, parallel to the first vertical plane and distinct therefrom. In FIG. 6, the arrangement of the light sources 2A, 2B is such that the first vertical plane in which the first light source 2A is located is closer to the collimator 4 than the first vertical plane in which the second light source 2B is located. Without departing from the scope of the invention, embodiments in which the second vertical plane is further from the collimator 4 than the first vertical plane could also be envisioned. One of these two vertical planes may moreover be substantially coincident with the object focal plane of the collimator 4. In particular, the second vertical plane in which the second light source 2B is placed may be the object focal plane of the collimator 4.

It will be understood from the above that the first light source 2A may be defocused, with a view to increasing the size of the spot of light formed in the context of the first luminous function, either by adding the additional lens 22, as is the case in the variant of FIG. 7, or by shifting the first light source 2A with respect to the second light source 2B along the optical axis O, as is the case in the variant of FIG. 6. These two variants could further be combined to obtain an embodiment in which the luminous module 1 has a first light source 2A offset with respect to a second light source 2B, and an additional lens 22 is inserted between this first light source 2A and the collimator 4.

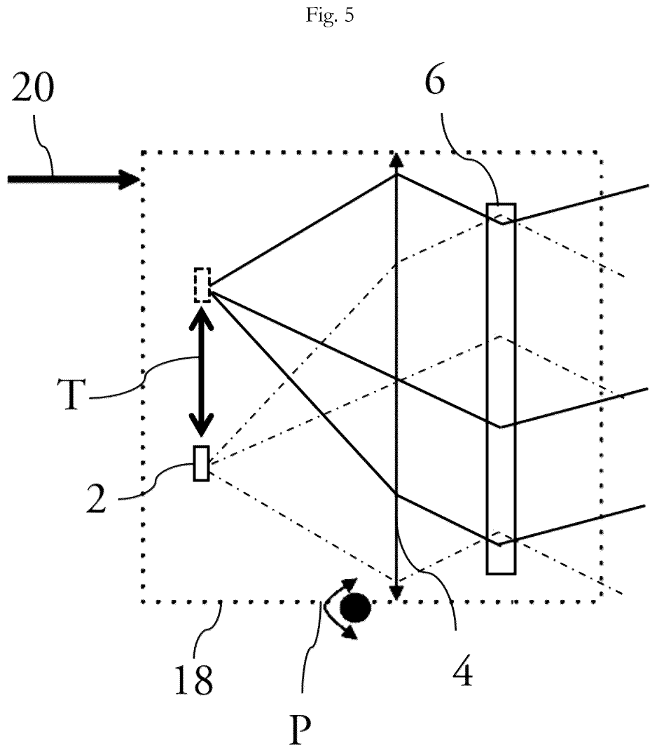

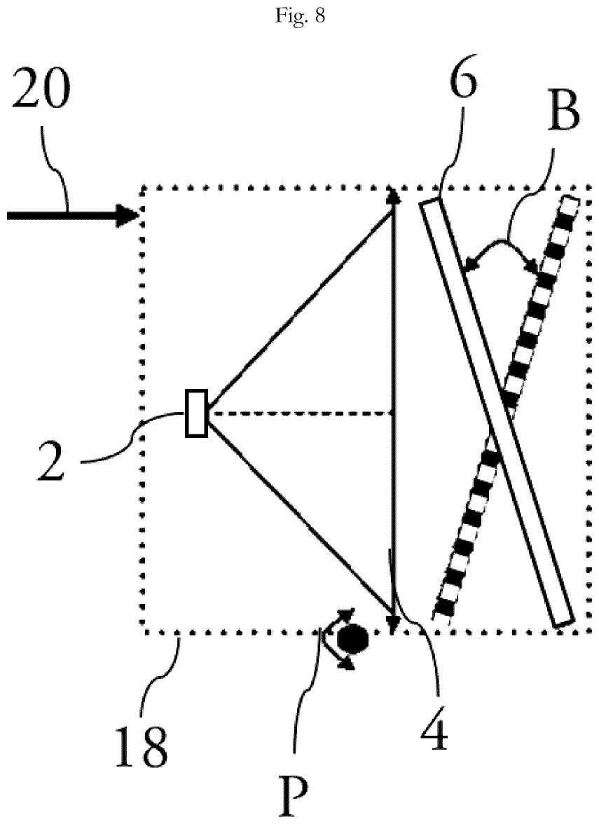

In the variants shown in FIG. 5 and FIG. 8, the luminous module 1 is equipped with a single light source 2. In order for the luminous module 1 to be able to perform both the first luminous function and the second luminous function, an additional movement to the pivoting movement of the housing is required. As illustrated in FIG. 5, this additional movement may be a movement of the light source 2. In this case, the light source 2 is able to move, and for example able to make a translational movement T, between a first position corresponding to the first luminous function and a second position corresponding to the second luminous function. Since the first luminous function requires a lower luminous intensity than the second luminous function, the light source 2 then has a variable luminous intensity allowing it to meet the prerequisites of each luminous function.

As shown in FIG. 8, the additional movement may otherwise be a movement of the microlens array device 6, the light source 2 then being fixed within the housing 18. The light source is here of variable luminous intensity as explained above. In this variant of embodiment, the microlens array device 6 is able to move, and here to make a rocking movement B; more precisely, this microlens array device 6 is configured to rock between a first angular position, in which it is able to perform the first luminous function, and a second angular position, in which it is able to perform the second luminous function. A rocking angle of the microlens array device 6 is then added to the angular offset of the housing 18 generated by the actuator 20. In this variant, implementation of each of the luminous functions corresponds firstly to rocking of the microlens array device 6, then secondly to pivoting of the housing 18.

Irrespectively of whether the light source 2 is moved or the microlens array device 6 rocked, this additional movement is controlled by an additional actuator, activation of which is added to activation of the actuator 20 of the housing 18. The actuator 20 and the additional actuator may both be controlled by the control unit. They may in particular both be controlled simultaneously, this making it possible to coordinate the movements of the housing 18 on the one hand and of either the light source 2 or the microlens array device 6 on the other hand.

The present invention thus provides a luminous module for automotive-vehicle capable of performing two distinct luminous functions, including a nighttime lighting function and a daytime signaling function, these two luminous functions resulting in luminous activation of the same area of the automotive vehicle both during the day and at night.

However, the present invention is not limited to the means and configurations described and illustrated here and it also extends to any equivalent means and configurations and to any technically operational combination of such means.

What is claimed is:

1. A luminous module for automotive vehicle configured to perform a first luminous function and a second luminous function distinct from the first luminous function, the luminous module comprising a housing in which are accommodated a light-emitting assembly, a collimator and a microlens array device, the light-emitting assembly being configured to emit light rays toward the microlens array device through the collimator with a view to alternately performing each of the two luminous functions, and an actuator, activation of which causes the housing to pivot during passage from one of the luminous functions to the other.

2. The luminous module as claimed in claim 1, wherein the first luminous function is a signaling function, such as a daytime-running-light function, and the second luminous function is a lighting function, such as a low-beam function.

3. The luminous module as claimed in claim 1, wherein the microlens array device includes an entrance microlens array, an exit microlens array and a mask, the mask being placed between the entrance microlens arrays and the exit microlens array.

4. The luminous module as claimed in claim 3, wherein the entrance microlens array has an image focal plane and the exit microlens array has an object focal plane, the image focal plane and the object focal plane being substantially coincident with the mask, the mask being opaque and containing apertures

5. The luminous module as claimed in claim 4, wherein each microlens of the entrance microlens array has an image focal plane, the light rays generated by the light-emitting assembly and participating in the first luminous function being focused on the image focal plane, at a first focal point away from the edges of the apertures of the mask, and the light rays generated by the light-emitting assembly and participating in the second luminous function being focused on the image focal plane, at a second focal point on the edge of an aperture of the mask.

6. The luminous module as claimed in claim 1, further comprising a control unit controlling the actuator.

7. The luminous module as claimed in claim 6, further comprising an additional actuator, activation of which causes a movement of at least part of the luminous module within the housing, the control unit being configured to control the actuator and the additional actuator simultaneously.

8. The luminous module as claimed in claim 7, wherein the microlens array device being configured to rock between a first angular position and a second angular position, the light-emitting assembly inlcudes a light source having a variable luminous intensity.

9. The luminous module as claimed in claim 7, wherein the light-emitting assembly includes a light source movable between a first position and a second position, the first position being associated with the first luminous function and the second position being associated with the second luminous function, the light source having a variable luminous intensity.

10. The luminous module as claimed in claim 1, wherein the light-emitting assembly includes a first light source configured to perform the first luminous function and a second light source configured to perform the second luminous function.

11. The luminous module as claimed in claim 10, wherein the collimator has an object focal plane, with the first light source and the second light source being placed in the object focal plane.

12. The luminous module as claimed in claim 10, wherein the first light source and the second light source are placed in two different vertical planes, each vertical plane being perpendicular to an optical axis of the luminous module, one of the light sources being closer to the microlens array device than the other light source.

13. The luminous module as claimed in claim 11, wherein the collimator has an object focal plane, the second light source being placed in this object focal plane and the first light source being offset with respect to the object focal plane.

14. The luminous module as claimed in claim 10, further comprising an additional lens placed between the first light source and the microlens array device.

15. The luminous module as claimed in claim 10, wherein the first light source and the second light source have different luminous intensities.

16. The luminous module as claimed in claim 1, wherein the actuator is configured to make the housing pivot by an angular offset of between 5 and 15°.

17. A method for using a luminous module, with the luminous module including a housing in which are accommodated a light-emitting assembly, a collimator and a microlens array device, the light-emitting assembly being configured to emit light rays toward the microlens array device through the collimator with a view to alternately performing each of two luminous functions, and an actuator, activation of which causes the housing to pivot during passage from one of the luminous functions to the other, comprising detecting the passage from a first luminous function to a second luminous function and causing the actuator to be activated to make the housing pivot from a first angular position to a second angular position, and detecting the passage from the second luminous function to the first luminous function and causing the actuator to be activated to make the housing pivot from the second angular position to the first angular position.
